(19) United States
(12) Patent Application Publication
(10) Pub. No.: US 2021/0081524 A1
(43) Pub. Date: Mar. 18, 2021

(54) SYSTEMS AND METHODS OF ESTABLISHING SECURE PASSWORDS USING REAL-TIME DYNAMIC FEEDBACK.

(71) Applicant: Whitestar Communications, Inc., Apex, NC (US)

(72) Inventor: William Victor Moon, Apex, NC (US)

(73) Assignee: Whitestar Communications, Inc., Apex, NC (US)

(21) Appl. No.: 16/574,497

(22) Filed: Sep. 18, 2019

(51) Int. Cl. G06F 21/46; G06F 21/62; G06F 21/32; G06F 21/36; G06F 21/70

(52) U.S. Cl. CPC G06F 21/46; G06F 21/62; G06F 2221/2137; G06F 21/36; G06F 21/70; G06F 21/32

(57) ABSTRACT

The present invention is systems and methods of establishing secure passwords using real-time dynamic feedback, comprising: selecting manual creation or automated suggestions at the time of creation of password for a system; creating a password manually or selecting one of the suggested passwords from an automated list; sending the selected password in clear text for evaluation; receiving an evaluation report on the strength of the password; analyzing whether the evaluation report meets the security threshold; confirming the password if the evaluation report meets or exceeds the security threshold; rejecting the password if the evaluation report is below the security threshold; after rejection going back to the step of creating the password manually or selecting another of the suggested passwords from the automated list.

If an Application Data Sheet (ADS) has been filed on the filing date of this application, it is incorporated by reference herein. Any applications claimed on the ADS for priority under 35 U.S.C. §§ 119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### FIELD OF THE INVENTION

The present invention is in the technical field of establishing secure passwords using real-time dynamic feedback related to estimated time of password expiry based on currently available hacking algorithms, number of dictionaries, number of words in the dictionaries, trending first and last names, and compute power of devices.

### BACKGROUND

Traditional password control systems typically rely on particular patterns (such as requiring some combination of upper and lower case letters along with a special character or a number along with a minimal number of total characters.) Additionally, it is normal in enterprise settings to require passwords to be changed on a fixed basis, i.e. fixed period of time requiring a fixed minimum length of characters. Both of these approaches have serious drawbacks. Requiring certain patterns within a password doesn't necessary give surety as to the strength of a password. Similarly, changing passwords on a fixed schedule only is a band-aid on the larger problem of not picking strong passwords. This leads to further problems as changing and rolling out a new passwords, particularly in an enterprise setting is filled with error and often causes issues that IT must then be engaged to correct.

There is no real-time or dynamic feedback back to a user based on the password he or she selects. The user is operating in the blind without key facts as to how easy it would be for someone to hack into his systems based on his password selection. With the ubiquitous use of the internet, online identity secured with passwords is becoming a critical part of our lives.

### SUMMARY OF THE INVENTION

The present invention is systems and methods of establishing secure passwords using real-time dynamic feedback, comprising: selecting manual creation or automated suggestions at the time of creation of password for a system; creating a password manually or selecting one of the suggested passwords from an automated list; sending the selected password in clear text for evaluation; receiving an evaluation report on the strength of the password; analyzing whether the evaluation report meets the security threshold; confirming the password if the evaluation report meets or exceeds the security threshold; rejecting the password if the evaluation report is below the security threshold; after rejection going back to the step of creating the password manually or selecting another of the suggested passwords from the automated list.

The systems and methods of establishing secure passwords using real-time dynamic feedback, receiving re-evaluation of the strength of the password at login time.

The systems and methods of establishing secure passwords using real-time dynamic feedback, wherein the evaluation report includes the number of days the password will expire based on one or more of the following: available number of dictionaries, number of words in the dictionaries, trending first or last names, and compute power of devices.

The systems and methods of establishing secure passwords using real-time dynamic feedback, further comprising, wherein: the evaluation report is based on automatically updated information for the dictionaries, trends and compute power.

The systems and methods of establishing secure passwords using real-time dynamic feedback, further comprising: creating an automated suggested password list using minimum number of characters required for a desired strength.

The systems and methods of establishing secure passwords using real-time dynamic feedback, further comprising: receiving re-evaluation of the password strength at login; receiving password change request when password is expired based on the dynamic re-evaluation.

The systems and methods of establishing secure passwords using real-time dynamic feedback, further comprising: requesting an audit of passwords or on-demand evaluation report for the set passwords wherein establishing the secure password is compatible with authentication protocols including OAuth or Multi-factor authentication; and runs as a client-side utility or an enterprise-wide service.

The systems and methods of establishing secure passwords using real-time dynamic feedback, wherein the selected password is a combination of one or more of the following: gestures, touch patterns, spatial patterns, or biometrics.

The systems and methods of establishing secure passwords using real-time dynamic feedback, wherein one or more selected passwords are automatically set for one or more systems with periodic updates; selecting a global password to trigger automated passwords for the set one or more systems.

The systems and methods of establishing secure passwords using real-time dynamic feedback, further comprising: using a secure and encrypted keyboard widget to create password manually or select from an automated list and send clear text password for evaluation.

### BRIEF DESCRIPTION OF THE DRAWINGS

The embodiments of this invention are illustrated by way of example and not limitation in the figures of the accompanying drawings, in which like references indicate similar elements and in which:

FIG. 1 shows a diagram illustrating an example of systems and methods of establishing secure passwords using real-time dynamic feedback with different types and categories of computing devices including networked or local systems.

FIG. 2 shows exploded view of a computing device with user interface for securing passwords, according to one embodiment.

FIG. 3 exploded view of a computing device with user interface for securing passwords at the reporting stage, according to one embodiment.

FIG. 4 is an exploded view of the modules or software components in a secure password system, according to one embodiment.

FIG. 5 shows a flowchart illustrating an example of a method of creating manual or automated passwords, according to one embodiment.

FIG. 6 shows a flowchart illustrating an example of a method of establishing secure passwords using real-time dynamic feedback, according to one embodiment.

FIG. 7 is a schematic diagram of exemplary computing devices that can be used to implement the methods and systems disclosed herein, according to one embodiment.

FIG. 8 shows a flowchart illustrating an example of a method of updating evaluation algorithms used in establishing secure passwords using real-time dynamic feedback, according to one embodiment.

FIG. 9 shows a flowchart illustrating an example of a method of updating evaluation algorithms with compute updates used in establishing secure passwords using real-time dynamic feedback, according to one embodiment.

FIG. 10 shows a flowchart illustrating an example of a method of updating dictionaries used in establishing secure passwords using real-time dynamic feedback, according to one embodiment.

### DETAILED DESCRIPTION OF THE INVENTION

The systems and methods of establishing secure passwords using real-time dynamic feedback includes techniques to incorporate currently known hacking algorithms, currently available dictionaries, number of words in dictionaries, currently trending first and last names and compute power capabilities of devices.

Rather than relying on a guess as to what patterns or length of password might be secure, the present invention uses commonly available hacking techniques and a temporally scaling model of compute power to estimate the time it would take a hacker to gain access to a subscriber's account based on the actual password chosen by that subscriber.

To aid in creating strong passwords, the present invention provides real time feedback, character by character as the subscriber enters a password as can be illustrated in the sequence of screen captures from a live test of the system in Figure W3. You will note eventually the password “fre168$Ha” is selected. In this case, present invention's autonomic password management system estimates that it will take 5 years to hack this password.

It should be noted that this estimate is “live” in that over the next 5 years, the present invention will continuously re-evaluate the chosen password and should new techniques, algorithms or unpredicted increases in compute power come along, then the present invention will revise the time that remains before the subscriber's password must change.

With its “continuous estimate” of the strength of a subscriber's password, the present invention then only insists that a subscriber change their password when necessary. This system greatly reduces the possibility of hacking.

Additionally, this system reduces collateral damage and drag on IT resources by not forcing passwords to be changed when they don't need to be. This is one of many novel systems within the present invention which have broad applicability to general software systems and not just the SOCIETY application.

To the extent, passwords are changed at a shorter frequency to avoid expiration or hacking, there is an added cost to the systems, especially in the enterprises, to replicate the passwords securely across the networked systems. The present invention helps with reducing the backend administrative costs associated with changing passwords.

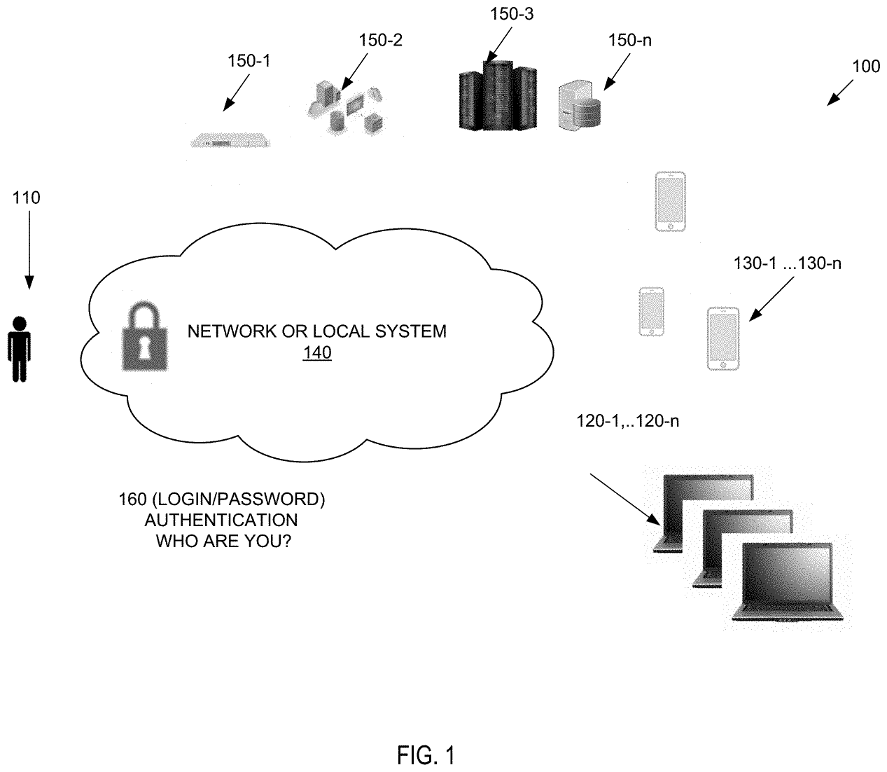

In one embodiment, FIG. 1 depicts a diagram 100 illustrating an example of establishing secure passwords for a user 110 using a computing devices through the network or local system 140. In the example of FIG. 1, the environment includes, a network or local system 140, personal computers from 120-1, . . . 120-n, smartphones from 130-1 to 130-n, servers from 150-1, . . . 150-n. Message 160 is the login/password message that flows through 140 system to authenticate user 110, i.e., identify who are you for the digital system access?

In an implementation, 110 user can manually create his or her own password or select one from a system recommended list or allows the system to automatically select a secure password for him. In one implementation, the password establishment hardware and software components enable receipt and execution of password setting commands directly on the device. In another implementation, 110 can use a speaker and/or microphone capability to enable receipt and execution of speech commands directly on the device. The devices are able to communicate with the user after authentication on the network or local system 140 to enable receipt and execution of commands that could also be translated to device specific SDK/API commands.

The role of the establishing a secure password for a user 110 is separated from the use of the computing devices. After purchase, a user of the computing device has control on how to use, configure and communicate using that device. Use of any central services including those from the device manufacturer become optional. Different categories of devices, for example, personal computers 120 are connected securely and with encryption and grant access only after authentication. Smartphones 130 and servers 150 with more computing power, bandwidth and capabilities are also connected. For example, the smallest computing device to the largest computing device benefit from establishing secure passwords.

A person of ordinary skill in the art would appreciate that by automating utility to set secure passwords using real-time dynamic feedback, the security level of all of the accessed systems in the network or local to the user is enhanced. The real-time dynamic feedback is achieved by using state of the art and most current hacking algorithms, dictionaries and compute power. These algorithms are periodically updated and provide real-time dynamic feedback each time the user logs in to a system. Different hacking algorithms include security packages that give feedback on passwords, new matching techniques, brute force matching, and/or dictionary matching. Snooping attacks by using malware to capture keyboard strokes or get video of you entering the password are prevented.

Compute power is based on central processing unit benchmarks and processing operations per second. For example, the Linux operating system provides utility bogo i.e. a kernel driver to give compute power of Linux machines. Utilities are available to compute how many keys per second are required to crack a password in million instructions per second (“mips”) per cycle.

A person of ordinary skill in the art would appreciate that the securing password is not tied to a single system or server. It can run as a client-side utility or an enterprise wide tool. The enterprise wide tool is compatible to security protocols including O-Auth and multi-factor authentication. A person of ordinary skill in the art would appreciate that the evaluation code of the password works on the clear text of the password that is only available at initial setup or login time. The password is stored in non-reversible ciphertext that cannot be stolen otherwise. A secure browser plugin using a client-side utility to evaluate the password may be used in conjunction with different password wallets or digital vaults. In one embodiment, different passwords for different apps can be stored securely using a digital vault that trigger the vault opening based on a secure global login. In one embodiment, the global login includes biometrics.

A user can delegate password changes to be automated across different apps and services that he or she uses. The user no longer has to worry or keep track as to when he or she needs to change the password. Such changes could occur automatically and propagate throughout the systems seamlessly. A person of ordinary skill in the art would appreciate that such a hassle-free password management is very beneficial. It saves time and resources both at the end-user end as well as IT and server or system ends.

Network or local system 140 can be different wireless and wired networks available to connect different computer devices including client and server systems. In an implementation, network 140 is publicly accessible on the internet through secure messaging protocol described herein. In an implementation, network 140 is inside a secure corporate wide area network. In an implementation, network 140 allows connectivity of different systems and devices using a computer-readable medium.

In one embodiment, the local system 140, comprises of a single personal computer that is used as a personal device for a user. In one embodiment, the local system 140 uses one or more of different operating systems, including for example, Windows, Android or MacOS. The methods and systems described herein are compatible with existing authentication modules from different operating systems.

The messaging and notification between different components can be implemented using application programming interface (API) calls, extensible markup language (“XML”) or Javascript Object Notation (“JSON”) config file interfaces between different interfaces, Hypertext Preprocessor (earlier called, Personal Home Page) (“PHP”), Python, Node.js, Java/C++ object-oriented programming or simple web-based tools.

Different components may also implement authentication and encryption to keep the data and the requests secure. Authentication of a user that uses a device may be accomplished using public/private key, token, transaction, biometrics, multi-factor authentication or other methods known in the industry that are used in conjunction with triggering passwords. Encryption may use data encryption standard (DES), TripleDES, RSA, Advanced Encryption Standard (AES) or other methods known in the industry.

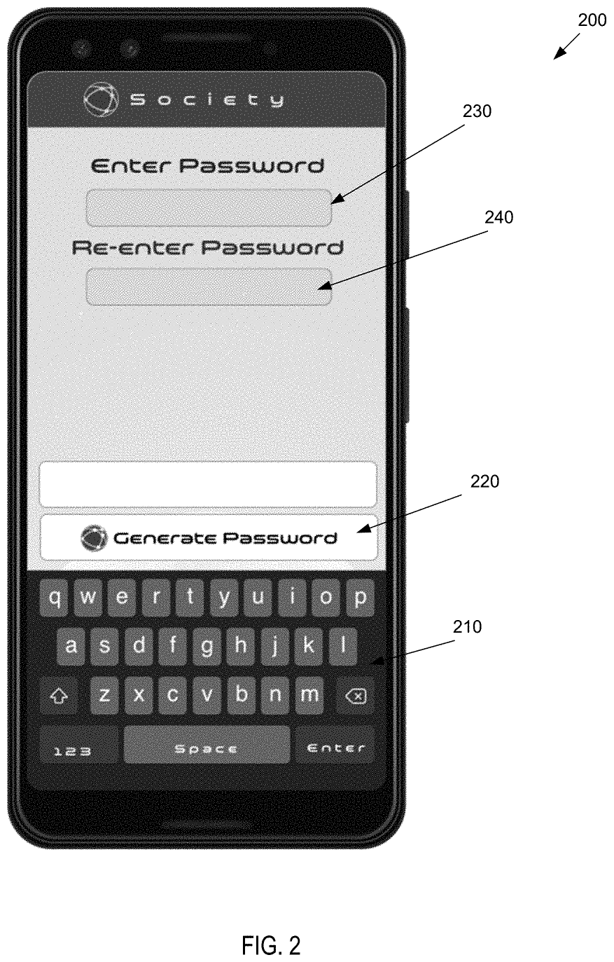

FIG. 2 is an exploded view 200 of a user interface for establishing a secure password in a computing device. For example, at 230 the password is requested and 240 requests the password to be re-entered at the time of setting the password. At 220, the user can select generate password for the system to automatically generate password. 210 shows a secure keyboard widget that is specially generated to get user passwords to ensure that hacking algorithms snooping keystrokes are not enabled on the computing device.

The secure keyboard widget could also include input that includes spatial patterns. For example, QWERTY, D AVORK, Standard keypad, Mac keypad allow for spatial patterns to be input. In one embodiment, gestures of rolling the device, twisting or turning etc. are also included. In one embodiment, touch patterns are included. In one embodiment, the gestures can be one or more of the following: any sequence of motions, such as shaking his device repeatedly some number of times, or rotating the device side to side several times, or pressing on the display in one or several places for a given amount of time, or even a simple alternative password that might be entered, or any combination of such things. In one embodiment, the secure keyboard widget is located at dynamically different locations on the screen.

In one embodiment, the computing device is a mobile application or widget that runs on a mobile smart phone. This could also be executed on a personal computer or a client application accessing servers on a network. A person of ordinary skill in the art would appreciate that the method of selecting a secure password is independent of the whether the system is local or networked. This secure password system could also be used in conjunction with smart vaults or wallets. In one embodiment, the user uses the secure password system with highly sensitive information related to finances, health etc.

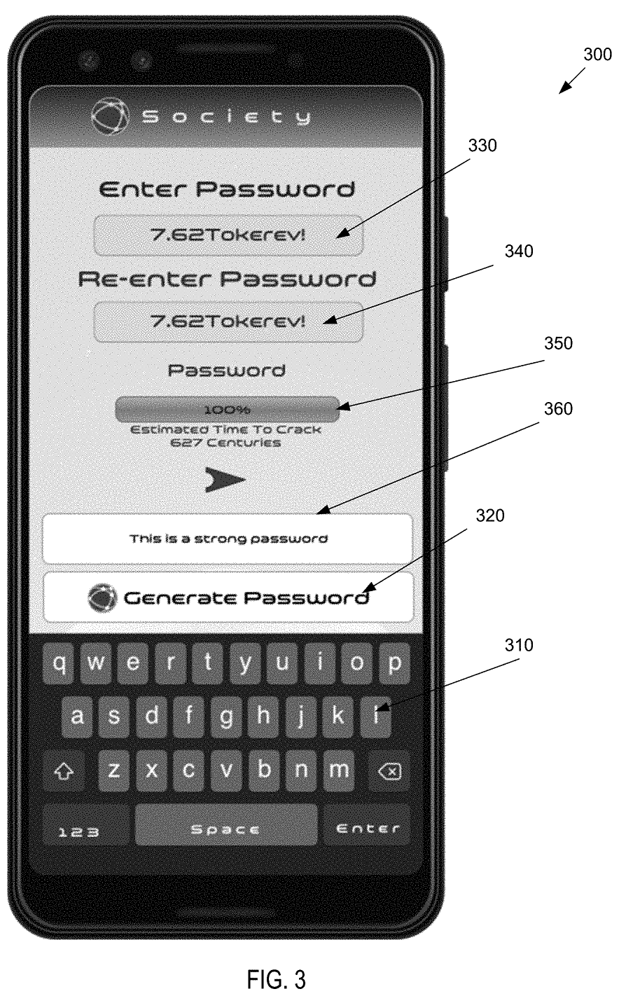

FIG. 3 outlines 300 showing user interface that receives real-time dynamic feedback from system of establishing secure password, according to one embodiment. At 310 is the secure keypad that can be used to make selections. At 320 is the utility to receive automated passwords created by the system. At 360 is the display that gives feedback on the selected password. 330 and 340 are used to enter and reenter the password. Duplication is required to ensure that there are no typographical errors in selecting passwords. At 350 a graphical report showing password strength and the estimated time to crack is given. This is real-time dynamic feedback from the system at the time of setting the password.

Based on the report and initial estimated time of expiry, the user can decide to confirm that password, or change it to get a more secure password. The user can then repeat the steps in FIG. 2 and FIG. 3 that go with input of the password creation. A person of ordinary skill in the art would appreciate that the feedback on how long before the password can be hacked gives an assessment as to the strength of the password.

In one embodiment, the user may use a global login that is based on a manually created password that is easy to remember that triggers setting of automated passwords on the servers and networks accessed by the user. In one embodiment, the user may select a higher password strength for sensitive applications using finance or health information. In one embodiment, the user may go for a less secure password for information related to photographs or social media that is of more personal nature and available only to private group members.

In one embodiment, the system alerts the user of failed login attempts and recommends an updated password expiry time based on the failed attempts. In one embodiment, the user can periodically request audit of the passwords set in different systems. In one embodiment, the audits are performed periodically. In one embodiment, the audits are requested on-demand.

The security threshold can be both for a maximum threshold as well as another level at a minimum threshold. In one embodiment, a maximum threshold limit is set. For example, if password is secure for 100 centuries, a user can feel secure that the password currently cannot be breached. Any period longer than 100 centuries defaults to that period. Such password though secure today, is periodically checked to ensure that it remains secure. New computing devices, dictionaries or hacking algorithms can put a password that is secure today at risk in the future.

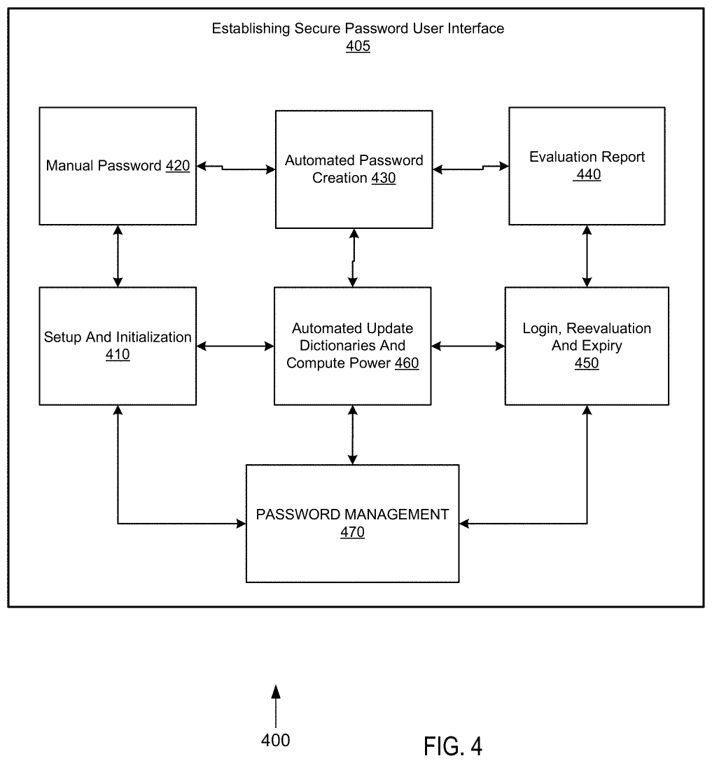

FIG. 4 with 400 shows software components or modules that are used in establishing a secure password on the client-side with a user interface 405. At 470, is the overall password management system that handles setting and expiry of passwords. At 410, the setup and initialization of the system occurs. This handles the number of passwords that the system needs to create and maintain including any audit or on-demand settings. At 420, the user is allowed to manually create a password. This includes use of a secure keyboard interface to get keystrokes from the user without a risk of keystroke snooping hacks. At 430, the system suggests one or more automated passwords. The evaluation report 440 gives feedback to the user in real-time as to the strength of the selected password. Such evaluation report is dynamically updated to include latest hacking algorithms, new dictionaries, new words in existing dictionaries, trending first and last names and computing power of devices.

An evaluation report 440 includes, for example, a grade as to whether the password is strong, medium or weak in strength. It could also include a graphical display, for example, an hour glass as to when the password is estimated to expire. In one embodiment, a user could request the evaluation report to be hidden and not displayed at each login. In one embodiment, the user is forced to change the password when expiry reaches a minimum threshold. In another embodiment, the display could be similar to a gas tank symbol used in cars that show how soon the tank will empty out, with requiring password change with fuel is low, i.e. password is estimated to expire soon.

A system is only as secure as its weakest link or weakest password. Incorporating the present invention helps reduce the threat level of the entire system. This reduces the risk that IT faces in an enterprise setting to ensure that users comply with password changes and using secure passwords. Since the updates are dynamic and based on real-time feedback, the guess work of whether a user is using secure passwords is entirely removed from the equation of uncertainty. The subjective bypassing of security options by users is no longer an issue.

A person of ordinary skill in the art would appreciate that computing power of devices increases with time as processors with faster speed, memory and bandwidth can harness faster computing power and do complex computations faster. With time, the computing power would affect the time to run the hacking algorithms to break a password. The present invention takes those factors and calculations in consideration to provide a realistic estimate of the strength of a password. The penetration testing that estimates the time of expiry for passwords includes state of the art and most current databases for hacking algorithms, dictionaries, trends and compute capacity of devices.

At 450, login, reevaluation and expiry are handled. With each login, a new realistic feedback is given. If a password has expired, based on system setting, the user may be forced to update or given grace period to change it. When using a global login, the system may automatically login to different servers as requested. The system may also automatically change passwords dynamically once set. At 460, the feedback received is based on dynamically updated information, i.e. updated dictionaries, addition of new dictionaries and compute power.

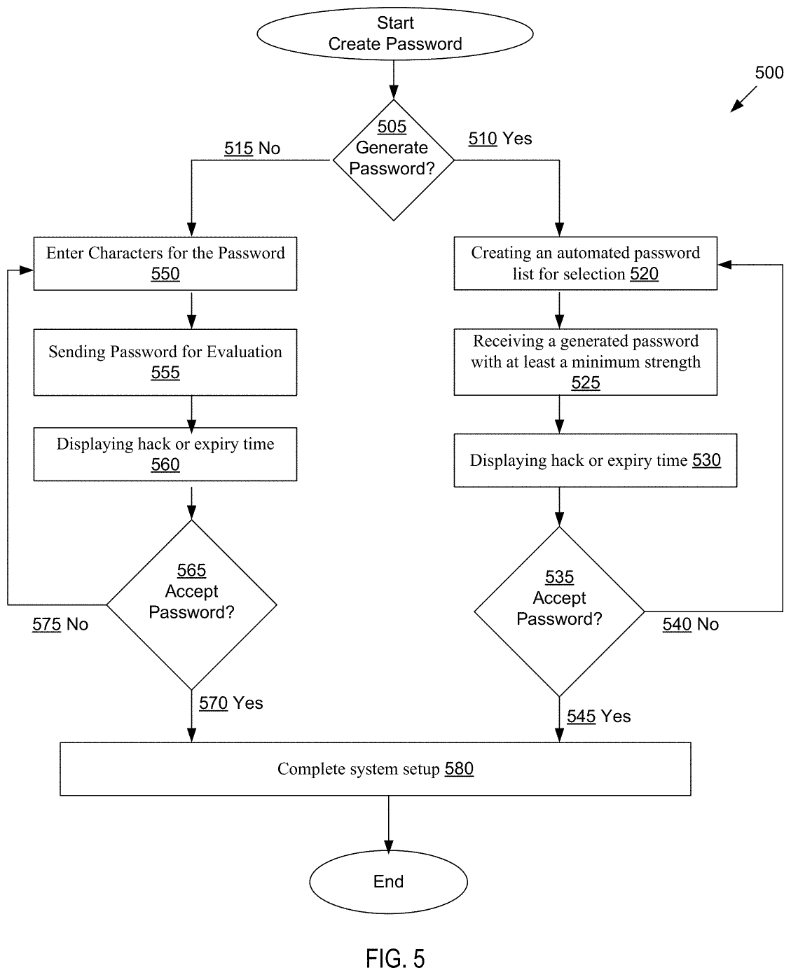

FIG. 5 with 500 shows a flowchart of password creation, according to one embodiment. At 505, a choice is requested as to whether to generate an automated password or create one manually? If yes is received, at 510 goes to creating automated passwords. At 520, one or more automated passwords are created. This is not a password list that is based on having very long characters. This length of the password is adjusted to what the local or network system can accept. At 525, the password is received with at least a minimum strength. At 530, the password expiry time and strength is displayed. At 535, the user can decide whether to accept the password and complete system set up at 580.

If the user wants to manually create a password, then No is received at 515. The user is then requested to enter characters for the password using a secure keyboard at 550. At 555, the password is sent for evaluation. At 560, the password expiry time and strength is displayed. At 565 the user can decide whether to accept the password and complete set up 580 or repeat the steps to go for a more secure or less secure password.

A person of ordinary skill in the art would understand that input can include gestures, spatial gestures, touch patterns or biometrics. The system setup 580 can be used for global setup or individually for each system local or network server. The flow chart of 580 can be a local client-side utility or a global enterprise-wide utility using O-Auth protocol.

The passwords created automatically and suggested to the user are of a length that is selected based on the desired security level and one that the system will accept. Many times the recommended passwords are arbitrarily very long and cannot be used because the underlying system will not accept such long passwords. The present invention creates passwords that are based on real-time and dynamic feedback and can also be put to use. In one embodiment, the user can give the number of characters required in the password and the desired strength. The present invention takes this input from the user to apply to the random password generation characters and recommends passwords accordingly.

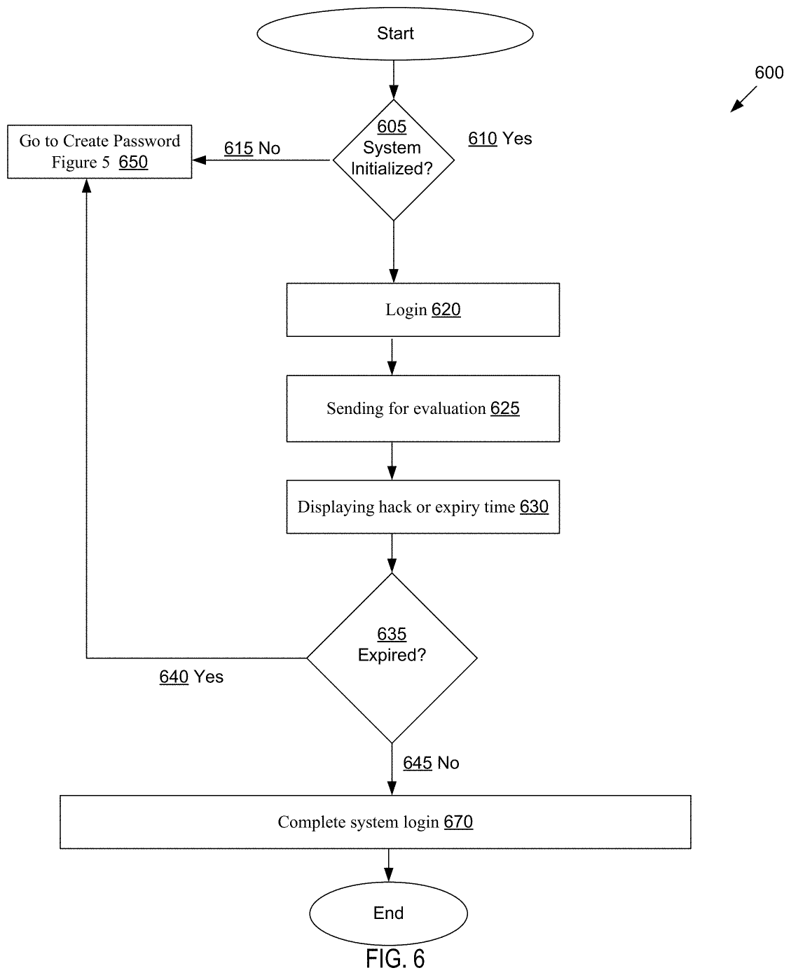

FIG. 6 depicts a flowchart 600 illustrating an example of a method of establishing secure passwords that is dynamically updated real-time. he flowchart 600 is discussed in conjunction with the environment shown in the diagram 100 in FIG. 1. At block 605, a check is made as to whether the system initialized? If 610, yes response is received, at block 620, the login step occurs. The password is received from the user, and sent for evaluation at block 625. Only if the user is authenticated with the correct password, a report displaying hack or expiry time occurs at 630.

If the password is about to expire, at block 635, then the user is asked to go to the create password module 650 as shown in FIG. 5. If the user is authenticated, the complete system login occurs at block 670. In the initial check, if the system is not initialized, 615 receives a No, the user is asked to go through create password at block 650 as shown in FIG. 5.

In a broad embodiment, the invention is systems and methods of establishing secure passwords using real-time and dynamic feedback. Using the latest hacking algorithms with updated dictionaries, words, current trending first or last names, and compute power, the system estimates hacking or expiry time for a given password and provides that feedback to the user.

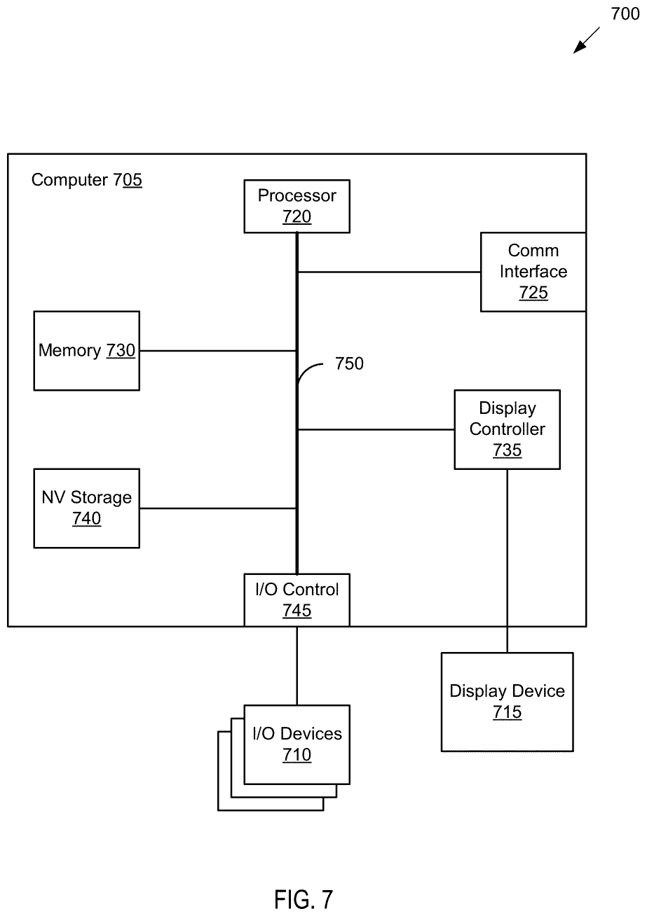

FIG. 7 is a schematic diagram of computing device 700 that can be used to implement the methods and systems disclosed herein, according to one or more embodiments. FIG. 7 is a schematic of a computing device 700 that can be used to perform and/or implement any of the embodiments disclosed herein. In one or more embodiments, IoT device 110, SDK/API 120, Speak-to-IoT system 130, voice assistants 150, user end devices with mobile apps 170 or 180 of FIG. 1 may be the computing device 700.

The computing device 700 may represent various forms of digital computers, such as laptops, desktops, workstations, personal digital assistants, servers, blade servers, mainframes, and/or other appropriate computers. The computing device 700 may represent various forms of mobile devices, such as smartphones, camera phones, personal digital assistants, cellular telephones, and other similar mobile devices. The components shown here, their connections, couples, and relationships, and their functions, are meant to be exemplary only, and are not meant to limit the embodiments described and/or claimed.

FIG. 7 shows an example of a computing device 700 on which techniques described here can be implemented. The computing device 700 can be a conventional computer system that can be used as a client computer system, such as a wireless client or a workstation, or a server computer system. The computing device 700 includes a computer 705, I/O devices 710, and a display device 715. The computer 705 includes a processor 720, a communications interface 725, memory 730, display controller 735, non-volatile storage 740, and I/O controller 745. The computer 705 may be coupled to or include the I/O devices 710 and display device 715.

The computer 705 interfaces to external systems through the communications interface 725, which may include a modem or network interface. It will be appreciated that the communications interface 725 can be considered to be part of the computing device 700 or a part of the computer 705. The communications interface 725 can be an analog modem, integrated services for digital networks (“ISDN”) modem, cable modem, token ring interface, satellite transmission interface (e.g. “direct personal computer” also known as “direct PC”), or other interfaces for coupling a computer system to other computer systems.

The processor 720 may be, for example, a conventional microprocessor such as an Intel Pentium microprocessor or Motorola power PC microprocessor. The memory 730 is coupled to the processor 720 by a bus 750. The memory 730 can be Dynamic Random Access Memory (DRAM) and can also include Static RAM (SRAM). The bus 750 couples the processor 720 to the memory 730, also to the non-volatile storage 740, to the display controller 735, and to the I/O controller 745.

The I/O devices 710 can include a keyboard, disk drives, printers, a scanner, and other input and output devices, including a mouse or other pointing device. The display controller 735 may control in the conventional manner a display on the display device 715, which can be, for example, a cathode ray tube (CRT) or liquid crystal display (LCD). The display controller 735 and the I/O controller 745 can be implemented with conventional well-known technology.

The non-volatile storage 740 is often a magnetic hard disk, an optical disk, or another form of storage for large amounts of data. Some of this data is often written, by a direct memory access process, into memory 730 during execution of software in the computer 705. One of skill in the art will immediately recognize that the terms “machine-readable medium” or “computer-readable medium” includes any type of storage device that is accessible by the processor 720 and also encompasses a carrier wave that encodes a data signal.

The computing device 700 is one example of many possible computer systems that have different architectures. For example, personal computers based on an Intel microprocessor often have multiple buses, one of which can be an I/O bus for the peripherals and one that directly connects the processor 720 and the memory 730 (often referred to as a memory bus). The buses are connected together through bridge components that perform any necessary translation due to differing bus protocols.

Network computers are another type of computer system that can be used in conjunction with the teachings described here. Network computers do not usually include a hard disk or other mass storage, and the executable programs are loaded from a network connection into the memory 730 for execution by the processor 720. A Web TV system, which is known in the art, is also considered to be a computer system, but it may lack some of the components shown in FIG. 7, such as certain input or output devices. A typical computer system will usually include at least a processor, memory, and a bus coupling the memory to the processor.

Though FIG. 7 shows an example of the computing device 700, it is noted that the term “computer system,” as used here, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller. An example of a computer system is shown in FIG. 7.

The memory can include, by way of example but not limitation, random access memory (RAM), such as dynamic RAM (DRAM) and static RAM (SRAM). The memory can be local, remote, or distributed. As used here, the term “computer-readable storage medium” is intended to include only physical media, such as memory. As used here, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory here. Even when software is moved to the memory for execution, the processor will typically make use of hardware registers to store values associated with the software, and local cache that, ideally, serves to speed up execution. As used here, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

A person of ordinary skill in the art would appreciate that establishing secure passwords allows for network wide or local system wide control and methods of multi-factor authentication can also be applied. The present invention works well with global login systems. The present invention allows for automated updates and changes of passwords that can be triggered and controlled through a global login.

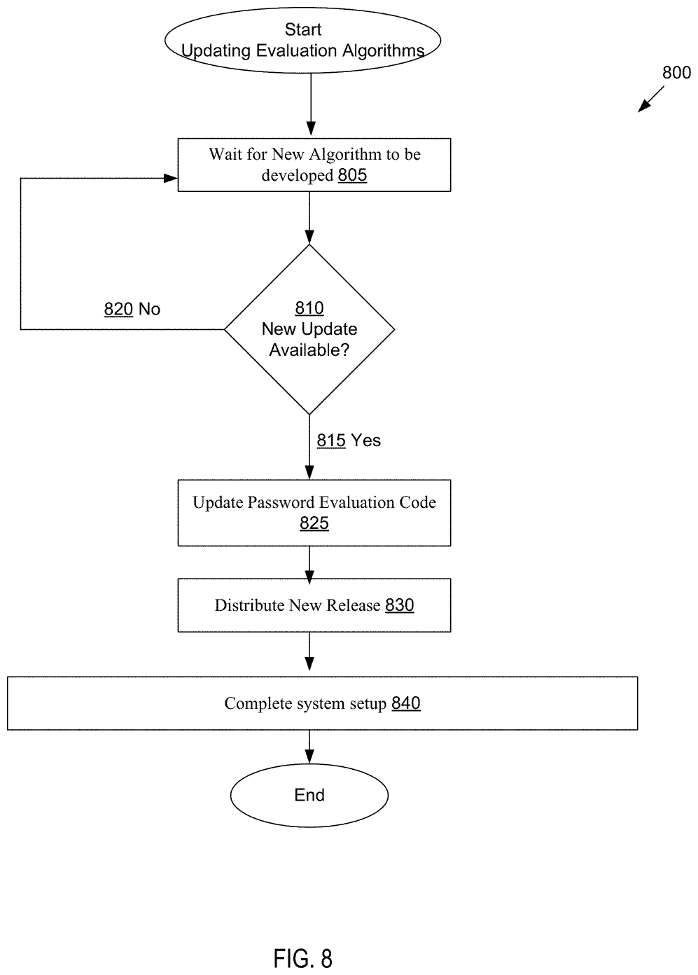

FIG. 8 shows an algorithm 800 where the system of the present invention automatically updates its evaluation algorithms, according to one embodiment. At block 805, the system is waiting for a new hacking algorithm to be developed. At block 810, there is a check whether a new update is available. If not 820, the system continues to wait in the background. At 815 yes, if there is a new update, the system at 825 downloads the new password evaluation code based on the new algorithm. At block 830, the new evaluation code is distributed to all the services running the evaluation code. At block 840, the system setup is completed.

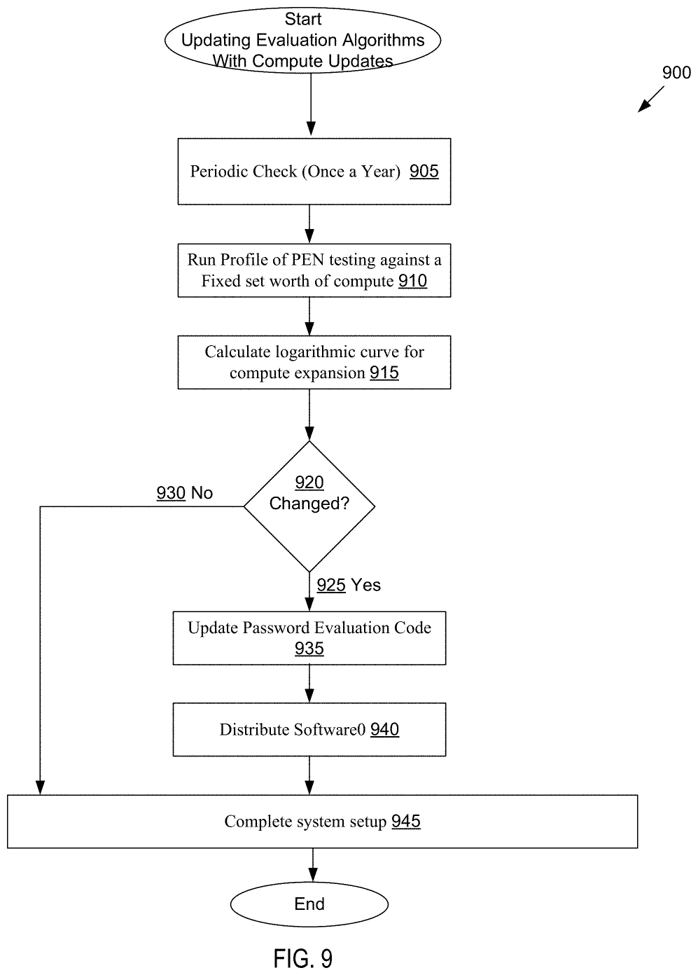

FIG. 9 is a flowchart 900 showing updating evaluation algorithm with compute updates, according to one embodiment. At 905, the system performs a periodic check, once a year or every six months to see if the computing power has increased for the devices available in the market. At 910, the system runs a profile of PEN (penetration) testing against a fixed set worth of compute. At block 915, the system calculates logarithmic curve for compute expansion. At block 920, a check is performed to see if there is a markable change. If not, at block 930, the system completes setup at 945. If yes, at block 925, the password evaluation code is updated to incorporate the change at 935. The updated evaluation code is distributed to all the services at 940. The system completes setup at 945.

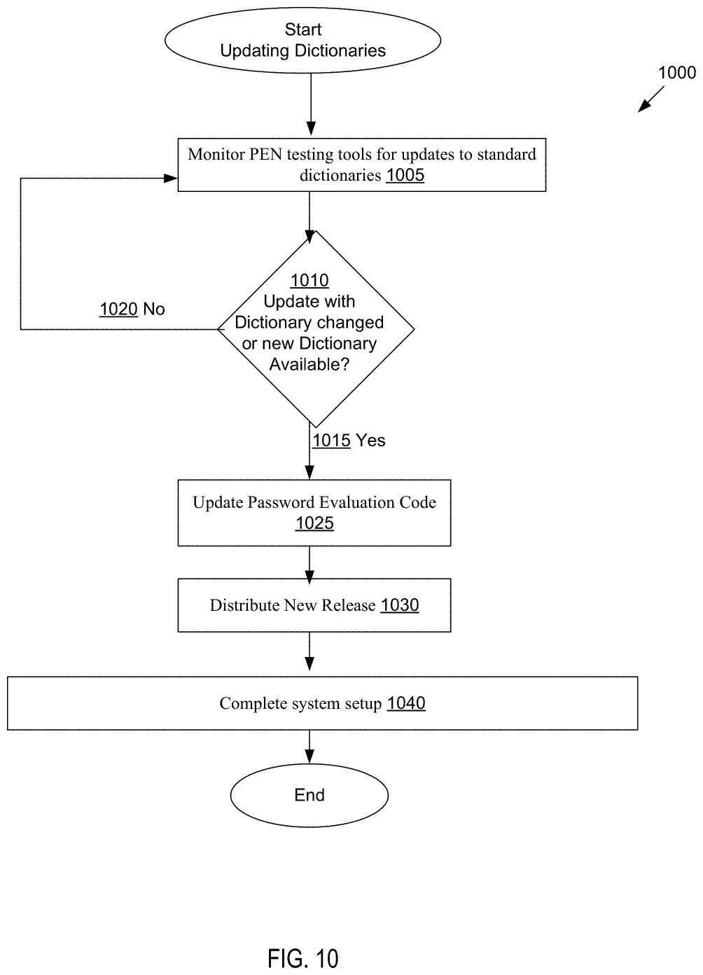

FIG. 10 is a flowchart 1000 showing updating dictionaries, according to one embodiment. At block 1005, the PEN testing tools monitor for updates to standard dictionaries including releases of any new dictionaries. At 1010, a check is performed to see update with dictionary change or if a new dictionary is available. If not, at 1020, goes back to monitoring for PEN testing for updates to standard dictionaries. If yes, at 1015, the password evaluation code is updated at 1025 to incorporate the new dictionaries or changes to existing dictionaries. A person of ordinary skill in the art would understand this would also incorporate any changes in trending names including first or last names. At block 1030, the updated evaluation code is distributed as a new release to all services using the evaluation code. At block 1040, the system setup is completed.

Dictionaries currently available for hacking passwords include, for example, the large urban dictionary eff, English, male names, female names, common passwords, surnames. Dictionaries have two dimensions. A brand new dictionary available in the market can be added to the evaluation code. The second dimension is the number of words or entries in the dictionary. The words within a dictionary can be priority ranked and ordered based on current trends. Typically when a password occurs as is in a dictionary, the password is perceived to be weak.

Several components described here, including clients, servers, and engines, can be compatible with or implemented using a cloud-based computing system. As used here, an overlay network including, for example, a peer to peer network, is a system that provides computing resources, software, and/or information to client systems by maintaining de-centralized services and resources that the client systems can access over a communications interface, such as a network. A person of ordinary skill in the art would understand that different modules or components described herein could be implemented using a cloud-based computing system. Such systems can involve a subscription for services or use a utility pricing model. Users can access the protocols of the private network through a web browser or other container application located on their client system.

The invention disclosure describes techniques that those of skill in the art can implement in numerous ways. For instance, those of skill in the art can implement the techniques described here using a process, an apparatus, a system, a composition of matter, a computer program product embodied on a computer-readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used here, the term ‘processor’ refers to one or more devices, circuits, and/or processing cores configured to process data, such as computer program instructions.

A detailed description of one or more implementations of the invention is provided here along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described here relate to apparatus for performing the operations. The apparatus can be specially constructed for the required purposes, or it can comprise a general-purpose computer selectively activated or reconfigured by a computer program stored in the computer. Such a computer program may be stored in a computer-readable storage medium, such as, but is not limited to, read-only memories (ROMs), random access memories (RAMS), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus. Although the foregoing implementations have been described in some detail for purposes of clarity of understanding, implementations are not necessarily limited to the details provided.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order. The structures and modules in the figures may be shown as distinct and communicating with only a few specific structures and not others. The structures may be merged with each other, may perform overlapping functions, and may communicate with other structures not shown to be connected in the figures.

The above-described functions and components may be comprised of instructions that are stored on a storage medium such as a computer readable medium. The instructions may be retrieved and executed by a processor. Some examples of instructions are software, program code, and firmware. Some examples of storage medium are memory devices, tapes, disks, integrated circuits, and servers. The instructions are operational when executed by the processor to direct the processor to operate in accord with some embodiments. Those skilled in the art are familiar with instructions, processor(s), and storage medium.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. A detailed description of one or more implementations of the invention is provided here along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The structures and modules in the figures may be shown as distinct and communicating with only a few specific structures and not others. The structures may be merged with each other, may perform overlapping functions, and may communicate with other structures not shown to be connected in the figures.

1. A method of establishing secure passwords using real-time dynamic feedback, comprising:
selecting manual creation or automated suggestions at the time of creation of password for a system;
creating a password manually or selecting one of the suggested passwords from an automated list;
sending the selected password in clear text for evaluation;
receiving an evaluation report on the strength of the password;
analyzing whether the evaluation report meets the security threshold;
confirming the password if the evaluation report meets or exceeds the security threshold;
rejecting the password if the evaluation report is below the security threshold;
after rejection going back to the step of creating the password manually or selecting another of the suggested passwords from the automated list.

2. The method of claim 1, receiving re-evaluation of the strength of the password at login time.

3. The method of claim 1, wherein the evaluation report includes the number of days the password will expire based on one or more of the following: available number of dictionaries, number of words in the dictionaries, trending first or last names, and compute power of devices.

4. The method of claim 3, further comprising, wherein:
the evaluation report is based on automatically updated information for the dictionaries, trends and compute power.

5. The method of claim 1, further comprising:
creating an automated suggested password list using minimum number of characters required for a desired strength.

6. The method of claim 1, further comprising:
receiving re-evaluation of the password strength at login;
receiving password change request when password is expired based on the dynamic re-evaluation.

7. The method of claim 1, further comprising:
requesting an audit of passwords or on-demand evaluation report for the set passwords wherein establishing the secure password is compatible with authentication protocols including OAuth or Multi-factor authentication; and
runs as a client-side utility or an enterprise-wide service.

8. The method of claim 1, wherein the selected password is a combination of one or more of the following: gestures, touch patterns, spatial patterns, or biometrics.

9. The method of claim 1, wherein one or more selected passwords are automatically set for one or more systems with periodic updates;
selecting a global password to trigger automated passwords for the set one or more systems.

10. The method of claim 1, further comprising:
using a secure and encrypted keyboard widget to create password manually or select from an automated list and send clear text password for evaluation.

11. A system of establishing secure passwords using real-time dynamic feedback, comprising: a user interface on a computing device configured to:
select manual creation or automated suggestions at the time of creation of password for a system;
create a password manually or selecting one of the suggested passwords from an automated list;
send the selected password in clear text for evaluation;
receive an evaluation report on the strength of the password;
analyze whether the evaluation report meets the security threshold;
confirm the password if the evaluation report meets or exceeds the security threshold;
reject the password if the evaluation report is below the security threshold;
after rejection go back to the step of creating the password manually or selecting another of the suggested passwords from the automated list.

12. The system of claim 11, further configured to: receive re-evaluation of the strength of the password at login time.

13. The system of claim 11, wherein the evaluation report includes the number of days the password will expire based on one or more of the following: available number of dictionaries, number of words in the dictionaries, trending first or last names, and compute power of devices .

14. The system of claim 13, further comprising, wherein:
evaluation report is based on automatically updated information for the dictionaries, trends and compute power.

15. The system of claim 11, further comprising, configured to:
create an automated suggested password list using minimum number of characters required for a desired strength.

16. The system of claim 11, further comprising, configured to:
receive re-evaluation of the password strength at login;
receive password change request when password is expired based on the dynamic re-evaluation.

17. The system of claim 11, further comprising:
request an audit of passwords or on-demand evaluation report for the set passwords wherein establishing the secure password is compatible with authentication protocols including OAuth or Multi-factor authentication; and
run as a client-side utility or an enterprise-wide service.

18. The system of claim 11, further comprising:
wherein the selected password is a combination of one or more of the following: gestures, touch patterns, spatial patterns, or biometrics.

19. The system of claim 11, further comprising:
wherein one or more selected passwords are automatically set for one or more systems with periodic updates;
select a global password to trigger automated passwords for the set one or more systems.

20. The system of claim 11, further comprising, configured to:
use a secure and encrypted keyboard widget to create password manually or select from an automated list and send clear text password for evaluation.
